(19) United States
(12) Patent Application Publication
(10) Pub. No.: US 2013/0058309 A1
(43) Pub. Date: Mar. 7, 2013

(54) METHOD AND APPARATUS FOR PERFORMING TIMING ADVANCE (TA) GROUP CHANGE IN A WIRELESS COMMUNICATION SYSTEM

(71) Applicant: Richard Lee-Chee Kuo, Taipei City (TW)

(72) Inventor: Richard Lee-Chee Kuo, Taipei City (TW)

(73) Assignee: INNOVATIVE SONIC CORPORATION, Taipei City (TW)

(21) Appl. No.: 13/605,028

(22) Filed: Sep. 6, 2012

Related U.S. Application Data
(60) Provisional application No. 61/531,379, filed on Sep. 6, 2011.

(51) Int. Cl. H04W 36/08

(52) U.S. Cl. 370/331

(57) ABSTRACT

A method and apparatus are disclosed to perform timing advance (TA) group change in a wireless communication system. The method includes configuring a Scell (Secondary Serving Cell) to a User Equipment (UE), wherein the Scell belongs to a first TA group. The method further includes sending a TA group change command from an eNB (evolved Node B) to the UE to change the Scell front the first TA group to a second TA group, wherein the eNB provides information together with the TA group change command so that the UE could derive an initial TA for the second TA group based on the information.

### CROSS-REFERENCE TO RELATED APPLICATIONS

The present Application claims the benefit of U.S. Provisional Patent Application Ser. No. 61/531,379 filed on Sep. 6, 2011, the entire disclosure of which is incorporated herein by reference.

### FIELD

This disclosure generally relates to wireless communication networks, and more particularly, to a method and apparatus for performing timing advance (TA) group change in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed for performing timing advance (TA) group change in a wireless communication system. The method includes configuring a Scell (Secondary Serving Cell) to a User Equipment (UE), wherein the Scell belongs to a first TA group. The method further includes sending a TA group change command from an eNB (evolved Node B) to the UE to change the Scell from the first TA group to a second TA group, wherein the eNB provides information together with the TA group change command so that the UE could derive an initial TA for the second TA group based on the information.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram illustrating, an exemplary scenario of a TA group change according to one exemplary embodiment.

FIG. 6 illustrates a message sequence chart according to one exemplary embodiment.

### DETAILED DESCRIPTION

The exemplary wireless .communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. TR 36.814, “Further Advancements for E-UTRA. Physical Layer Aspects (Release 9)”; TS 36.321 V10.2.0, “E-UTRA; MAC Protocol Specification”; RP-110451, “WID: LTE Carrier Aggregation Enhancements”; R2-113578, “Updates of Carrier Aggregation Agreements (WI R2-110451)”; R2-114020, “TA Group Configuration”; R2-114169, “Group Management for Multiple TA”. The standards and documents listed above are hereby expressly incorporated herein.

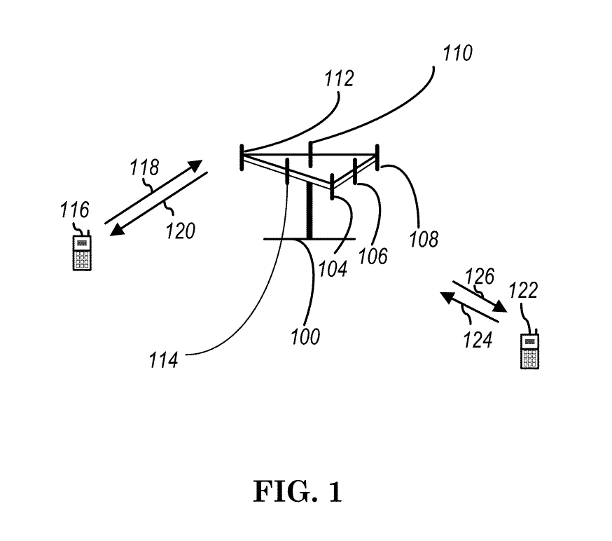

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

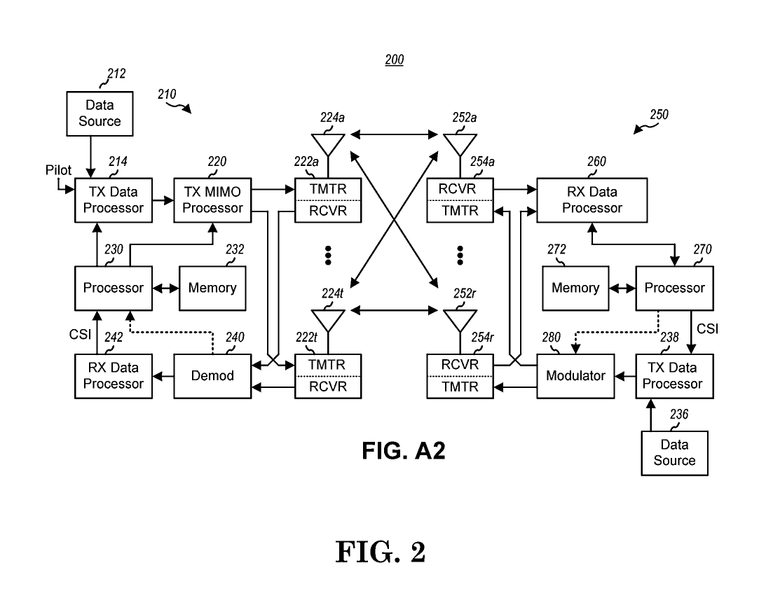

FIG. 2 is a simplified block diagram of an embodiment of a transmitter system. 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected, for that data stream to provide coded data.

The coded data for each data stream may be multiplexed with pilot data using OFDM techniques. The pilot data is typically a known data pattern that is processed, in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM), TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel, N_{T} modulated signals from transmitters 222a through 222t are then transmitted from N_{T} antennas 224a through 224t, respectively,

At receiver system 250, the transmitted modulated signals are received by N_{R} antennas 252a through 252r and the received signal from each antenna 252 is provided, to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message..

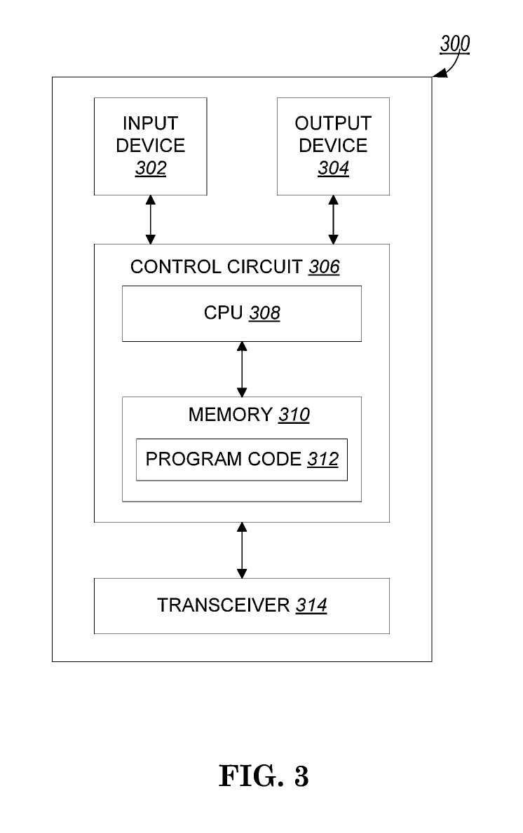

Turning to FIG. 3, this figure shows an alternative, simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

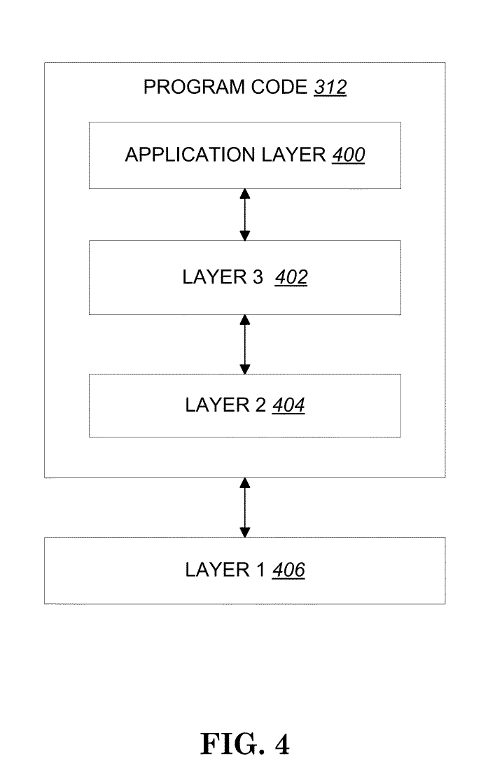

FIG. 4 is a simplified block diagram of the program code 312 shown in FIG. 3 in accordance with one embodiment of the invention. in this embodiment, the program code 312 includes an application layer 400, a Layer 3 portion 402, and a Layer 2 portion 404, and is coupled to a Layer 1 portion 406. The Layer 3 portion 402. generally performs radio resource control. The Layer 2 portion 404 generally performs link control, The Layer 1 portion 406 generally performs physical connections.

Carrier aggregation (CA) is a feature to support wider bandwidth in LTE-Advanced (LTE-A). A terminal may simultaneously receive or transmit on one or multiple component carriers (CCs) depending on its capabilities, as discussed in 3GPP TR 36.814.

In addition to a primary serving cell (Pcell), a UE in RRC_CONNECTED mode may be configured with other secondary serving cells (Scell). Typically, The Pcell is considered as always activated, while an Activation/Deactivation MAC Control Element (CE) could be used to activate or deactivate the Scell, as discussed in 3GPP TS 36.321 V 10.2.0. In general, a configured Scell may contain one downlink (DL) CC or one DL CC as well as one uplink (UL) CC.

Different UEs in a cell may have different TA values. The general purpose of the TA values is to ensure that a UE's uplink transmissions arrive at a cell without overlapping with transmissions from other UEs in the same cell. According to 3GPP TS346.211 V 10.2.0 section 8.1. transmission of an uplink radio frame from the UE shall start N_{TA} seconds before the start of the corresponding downlink radio frame at the UE, where N_{TA} is the TA value.

In Rel-10, a random access procedure is performed by a UE to obtain the initial TA value from the eNB as described in 3GPP TS 36.321 V102.0. The initial TA value is typically included in a random access response message sent from the eNB. Then, the TA value may be updated via an MAC control element from the eNB. Each time when the TA value is updated, the corresponding TA timer would be restarted. And, no uplink transmission would be allowed in the UE if the TA timer expires.

As indicated in 3GPP RP-110451, a new work item (WI) for LTE (Long Term Evolution) CA enhancement was agreed at the RAN#51 meeting. One objective of this WI is to support multiple timing advances (TAs) in case of LTE uplink CA. In addition, there were discussions in RAN2#74 on multiple TAs and related agreements are captured in 3GPP R2-113578 as follows:

### I.X Multiple Timing Advances

This subclause reflects the agreements reached on carrier aggregation enhancements for Rel-11 that may not necessarily fit in the core of the specification but which needs to be captured in the absence of corresponding details in Stage 3 specifications.

Serving cells having UL to which the same TA applies (typically corresponding to the serving cells hosted by the same receiver) are grouped in a TA group. Each TA group contains at least one serving cell with configured uplink, and the mapping of each serving cell to a TA group is configured by the serving eNB. A UE supporting multiple TAs is required to support at least 2 TA groups.

With respect to TA maintenance:
TA maintenance for the TA group containing the PCell follows Rel-10 principles;
To obtain initial UL time alignment for a SCell not grouped together with the PCell, eNB initiated RA procedure may be used;
The number of time alignment timer (TAT) to be maintained is FFS (one per UE or one per TA group);

With respect to the RA procedure on SCell(s):
The eNB may initiate the RA procedure via a PDCCH order for an activated SCell. This PDCCH order is sent on the scheduling cell of this SCell. At least non-contention based RA procedure will be supported, FFS if contention based RA procedure is also supported.

NOTE: FFS whether other RA procedure triggers on SCells than the PDCCH order are introduced (UE autonomous and/or eNB initiated). FFS whether cross-carrier scheduling can take place in the RA procedure and whether all steps need to be located on the same SCell. FFS whether multiple RA procedures can be running in parallel.

The following agreements on TA grouping were made it the RAN2#75 meeting: Agreements:

1a) Will go for solution with one TAT per TAG

b) Will enable usage of separate values for the different TAG's

2) When the TAT associated with Pcell expires, all TAT's are considered expired i.e. and the UE follows the R10 behavior, i.e. the UE flushes all HARQ buffers, clears any configured assignments/grants, and RRC releases PUCCH/SRS for all configured serving cells.

4) When the TAT associated with an Scell TAG expires, p1 SRS transmissions in Scell TAG shall be stopped (FFS if SRS configuration is released)
CQI/PMI/RI reporting configuration for the SCells is maintained.
MAC flushes all uplink HARQ buffers for the concerned SCells.

Agreements:

1) We need to support TAG change except for Pcell.

2) So far no strong need identified for additional assistance information from UE. Discussion can continue.

In addition, 3GPP R2-114020 proposes that the eNB relies on uplink timing calculation based on a random access preamble sent on a Scell from a UE to determine the TA group for the Scell and signals the TA group information in the random access response (RAR) corresponding to the preamble, while 3GPP R2-114169 proposes using an Activation/Deactivation MAC Control Element to assign a Scell to a TA group.

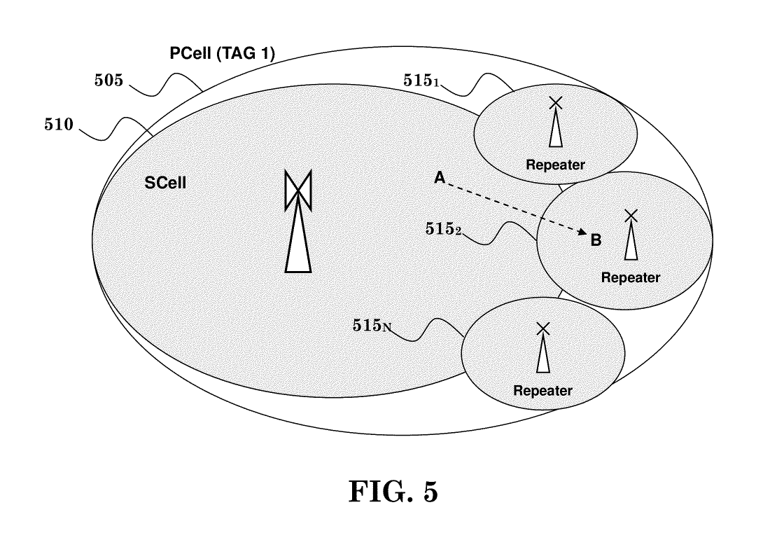

As shown in FIG. 5, when a UE moves within a Scell 510 configured with frequency selective repeater(s) 515₁, 515₂, . . . , 515_{N}, the TA value corresponding to this Scell 510 may change as compared to the TA value corresponding to other serving cells in the same TA group, which implies a TA group change for this Scell 510 is needed. As further shown in FIG. 5, the Pcell 505 overlaps with the Scell 510 which is extended using repeaters 515₁, 515₂, . . . , 515_{N}. At location A the Scell 510 may share the same TA value with the Pcell 505 to indicate that both the Scell and the Pcell 505 belong to the same TA group (TAG1). When the UE moves into the coverage of a repeater of the Scell 510 (e.g., location B), the propagation delays via the Pcell 505 and the Scell 510 may be different because the UE transmissions toward the Pcell 505 go directly to the Pcell 505 while the UE transmissions toward the Scell 510 reaches the Scell 510 via the repeater 515₂. In this situation, a TA group change for this Scell 510 may be needed.

In general, when a UE moves within a Scell, the eNB may detect TA change based on uplink transmissions from the UE. Thus, it could be expected that TA group change would mostly occur when the TA timer associated with the Scell or the TA group of the Scell is running. If the Scell is moved to another TA group associated with a running TA timer, the UE could continue uplink transmissions on the Scell with the TA associated with the TA group. No extra action needs to be taken by the UE except changing the TA group for the Scell.

On the other hand, if the Scell forms a new TA group after TA group change, some extra handling may be needed. Since the eNB detects TA change based on uplink transmissions from the UE, it should be possible for the eNB to estimate the TA value based on uplink transmission (i.e. without relying on a random access procedure) and provide a TA command along with the TA group change command for the UE to derive the initial TA corresponding to the new TA group so that uplink transmissions on the Scell could continue right away after transition to the new TA group. Typically, the initial transmit power on the Scell is determined based on the last transmit power used during the random access procedure which is performed for obtaining the initial TA. In the situation where no random access procedure is performed, the eNB could also provide information together with the TA group change command so that the UE could determine the initial transmit power on the Scell.

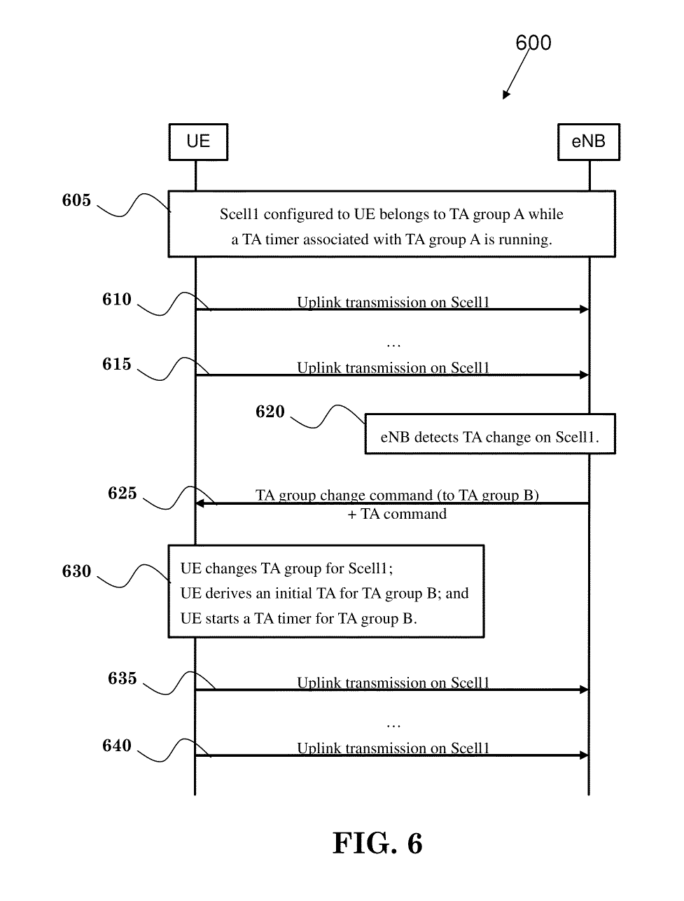

FIG. 6 illustrates a message chart 600 in accordance with one exemplary embodiment. In step 605, a Scell (labeled as Scell1) belonging to a TA group (labeled as TA group A) is configured to a UE. In steps 610 and 615, uplink transmissions are performed on Scell1. In Step 620, the eNB detects a TA change on Scell1. In step 625, the eNB sends a TA group change command and a TA command to indicate that. Scell1 should change from TA group A to TA group B. In step 630, upon receipt of the TA group change command and the TA command, the UE changes Scell1 from TA group A to TA group B. The UE also derives an initial TA for TA group B based on the TA command, and starts a TA timer for TA group B. In steps 635 and 640, uplink transmissions are performed on Scell1 according to the new TA.

Referring back to FIGS. 3 and 4, the UE 300 includes a program code 312 stored in memory 310. In one embodiment, the CPU 308 could execute the program code 312 (i) to configure a Scell (Secondary Serving Cell) to a User Equipment (UE), wherein the Scell belongs to a first TA group, and (ii) to send a TA group change command from, an eNB (evolved Node B) to the UE to change the Scell from the first TA group to a second TA group, wherein, the eNB provides information (such as a TA command) together with the TA group change command so that the UE could derive an initial TA for the second TA group.

In addition, the CPU 308 can execute the program code 312 to perform all of the above-described actions and steps or others described herein.

Furthermore, in one embodiment, the information (such as a TA command) could be included in a MAC Control Element that is used for transmitting the TA group change command. Alternatively, the TA command could be included in one (or first) MAC Control Element while the TA group change command could be included in a different (or second) MAC Control Element. Also, the first and second MAC Control Elements could be transmitted in one transport block. In addition, the TA command could be included in a RRC (Radio Resource Control) message (such as a RRC Connection Reconfiguration message) used for transmitting the TA group change command.

Also, in one embodiment, the UE would derive the initial TA for the second TA group based on the TA command when transitioning to the second TA group. In addition, the TA command could indicate a TA value corresponding to the second TA group that is different from the TA value corresponding to the first TA group. The TA command could also indicate a differential value to the TA value corresponding to the first TA group. In general, the sum of differential value and the TA value corresponding to the first TA group would represent the TA value corresponding to the second TA group.

In addition, in one embodiment, the UE would start a TA timer corresponding to the second TA group when transitioning to the second TA group. Also, the UE would prohibit uplink transmissions on Scells in a particular TA group after the TA timer corresponding to the group expires. In this embodiment, Scells in a TA group would share the same TA value for uplink transmissions. Furthermore, a TA timer would be started (or restarted) when a corresponding TA is initialized or updated.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed, herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks., modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM Memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for performing TA (Timing Advance) group change in a network node in a wireless communication system, comprising;
configuring a Scan (Secondary Serving Cell) to a User Equipment (UE), wherein the Scell belongs to a first TA group; and
sending a TA group change command to the UE to change the Scell from the first TA group to a second TA group;
wherein information is provided together with the TA group change command so that the UE could derive an initial TA for the second TA group based on the information.

2. The method of claim 1, wherein the information is a TA command.

3. The method of claim 1, wherein the information is included in a MAC Control Element used for transmitting the TA group change command.

4. The method of claim 1, wherein the information included in a first MAC Control Element and the TA group change command included in a second MAC Control Element are transmitted in one transport block.

5. The method of claim 1, wherein the information is included in a RRC (Radio Resource Control) message used for transmitting the TA group change command.

6. The method of claim 4, wherein the RRC message is a RRC Connection Reconfiguration message.

7. The method of claim 1, wherein the information indicates a TA value corresponding to the second TA group or a differential value to a TA value corresponding to the first TA group.

8. A communication device for performing TA (Timing Advance) group change in a wireless communication system, the communication device comprising:
a control circuit;
a processor installed in the control circuit;
a memory installed in the control circuit and operatively coupled to the processor;
wherein the processor is configured to execute a program code stored in memory to perform TA group change by:
configuring, a Scell (Secondary Serving Cell) to a User Equipment (UE), wherein the Scell belongs to a first TA group; and
sending a TA group change command to the UE to change the Scell from the first TA group to a second TA group;
wherein information is provided together with the TA group change command for the UE to derive an initial TA for the second TA group based on the information.

9. The communication device of claim 8, wherein the information is a TA command.

10. The communication device of claim 8, wherein the information is included in a MAC Control Element used for transmitting the TA group change command.

11. The communication device of claim 8, wherein the information included in a first MAC Control Element, and the TA group change command included in a second MAC Control Element are transmitted in one transport block.

12. The communication device of claim 8, wherein the information is included in a RRC (Radio Resource Control) message used for transmitting the TA group change command.

13. The communication device of claim 8, Wherein the information indicates a TA value corresponding to the second TA group or a differential value to a TA value corresponding to the first TA group.

14. A method for performing TA (Timing Advance) group change in a User Equipment (UE) in a wireless communication system, comprising:
configuring a Scell (Secondary Serving Cell), wherein the Scell belongs to a first TA group;
receiving a TA group change command from an evolved Node B (eNB) to change the Scell from the first TA group to a second TA group; and
deriving an initial TA for the second TA group based on information which is provided together with the TA group change command.

15. The method of claim 14, wherein the information is a TA command.

16. The method of claim 14, wherein the information is included in a MAC Control Element used for transmitting the TA group change command.

17. The method of claim 14, wherein the information included in a first MAC Control Element and the TA group change command included in a second MAC Control Element are transmitted in one transport block.

18. The method of claim 14, wherein the information is included in a RRC (Radio Resource Control) message used for transmitting the TA group change command.

19. The method of claim 14, wherein the information indicates a TA value corresponding to the second TA group or a differential value to a TA value corresponding to the first TA group.

20. The method of claim 14, wherein the UE starts a TA timer corresponding to the second TA group when changing the Scell from the first TA group to the second TA group.
